(19) United States
(12) Patent Application Publication
(10) Pub. No.: US 2011/0059685 A1
(43) Pub. Date: Mar. 10, 2011

(54) SLIDE DAMPER DEVICE

(75) Inventor: Minoru IDO, Tochigi-ken (JP)

(73) Assignee: KEIHIN CORPORATION, Tokyo (JP)

(21) Appl. No.: 12/876,684

(22) Filed: Sep. 7, 2010

(30) Foreign Application Priority Data
Sep. 8, 2009 (JP) 2009-207454
Sep. 8, 2009 (JP) 2009-207455
Sep. 8, 2009 (JP) 2009-207456

(51) Int. Cl. B60H 1/00

(52) U.S. Cl. 454/69

(57) ABSTRACT

A slide damper device comprising: a case of an air conditioning device for a vehicle; a slide damper; a plate-like guide rail provided on an inner wall of the case; a connection member provided at a side end part of the slide damper, the connection member having a concave shape slidably fitting with the guide rail, the connection member connecting the slide damper to the guide rail, wherein an opening of a flow path provided inside the case is adjusted by sliding the slide damper.

### BACKGROUND OF THE INVENTION

The present application claims priority on Japanese Patent Application No. 2009-207454, filed Sep. 8, 2009; Japanese Patent Application No. 2009-207455, filed Sep. 8, 2009; and Japanese Patent Application No. 2009-207456, filed Sep. 8, 2009, the contents of which are incorporated herein by reference.

### FIELD OF THE INVENTION

The present invention relates to a slide damper device.

### DESCRIPTION OF THE RELATED ART

According to an air conditioning device for vehicles (HVAC: Heating Ventilation Air Conditioning), a slide damper device is used as an air mixing damper device which adjusts the ratio with which cold air and warm air is mixed, and an internal/external air swiching damper device which switches between a state of introducing external air and a state of circulating internal air. The above-mentioned slide damper device adjusts an opening of a flow path by sliding a slide damper, for example.

In particular, the slide damper device adjusts the opening of the flow path by moving a slide damper between two openings which are approximately the same size and are positioned in parallel, thereby changing a ratio at which the two openings are opened.

Conventionally, according to such a slide damper device, a guide groove is provided on an inner wall of a case comprised by an air conditioning device for vehicles, and a connection member protruding from a side end part of a slide damper is slidably fitted to the guide groove. As a result, the slide damper moves along the guide groove. (See Japanese Patent No. 3793309 (hereinafter referred to as Patent Document 1), Japanese Patent No. 2831325 (hereinafter referred to as Patent Document 2), and Japanese Patent No. 3504806 (hereinafter referred to as Patent Document 3).)

Incidentally, the case comprised by the air conditioning device for vehicles is large and is shaped intricately compared to a simple, planar slide damper. Such a case is more subject to a large amount of displacement due to a deformation compared to a slide damper. Thus, there is a large dimension error during manufacture. Therefore, the width of the guide groove combined with the case should usually be sufficiently large enough so that the slide damper may move in a smooth manner.

However, an increase in the width of the guide groove leads to an increase in the width of a gap between a side wall comprised by the guide groove and the connection member fitted to the guide groove. This gap may cause a fluid from an upstream of the side damper to a downstream to leak out.

In other words, regarding conventional slide damper devices, a gap between a side wall and a connection member comprised by the guide groove becomes larger, thereby causing a large amount leakage of a fluid from the upstream of the slide damper to the downstream.

Japanese Unexamined Patent Application, First Publication No. H9-290618 (hereinafter referred to as Patent Document 4), for instance, discloses a slide damper device preventing a leakage of the fluid by utilizing a configuration in which a connection member is provided at all regions of the side end part of the slide damper. In other words, the side end part of the slide damper itself is used as a connection member.

However, even when such a configuration is used, the width of the guide groove must be wide enough with respect to the thickness of the connection member. Therefore, the leakage of the fluid cannot be adequately prevented.

Meanwhile, it may be also possible to reduce the dimension error which occurs when manufacturing the guide groove by manufacturing the guide groove separately from the guide groove and then attaching the guide groove to an inner wall of the case.

Thus, the dimension error when manufacturing which occurs when manufacturing the guide groove may be reduced, the gap between the side wall and the connection member comprised by the guide groove may be reduced, and the leakage of the fluid can be prevented.

However, in such a case, the number of components of the air conditioning device for the vehicle increases. As a result, the manufacturing cost also increases.

On the other hand, a guide groove and a connection member provided on a side end part of a slide damper slide while a surface is always being in contact with the guide groove.

Therefore, a frictional resistance caused between the guide groove and the connection member increases. Hence, the slide damper may be prevented from sliding smoothly.

In particular, as in Patent Document 4, when the connection member is provided on all areas of the side end part of the slide damper, the frictional resistance becomes very large. Hence, moving the slide damper may become impossible.

### SUMMARY OF THE INVENTION

The present invention is made considering the problems described above. Accordingly, an object of the present invention is to provide a slide damper device such that a leakage of a fluid from an upstream of a slide damper to a downstream can be prevented without increasing the number of components of an air conditioning device for a vehicle.

Further, an object of the present invention is to provide a slide damper device such that a slide damper may move smoothly.

(1) Namely, a slide damper device according to an aspect of the present invention comprises a case of an air conditioning device for a vehicle; a slide damper; a plate-like guide rail provided on an inner wall of the case; and a connection member provided at a side end part of the slide damper. The connection member has a concave shape slidably fitting with the guide rail. The connection member connects the slide damper to the guide rail. Here, an opening of a flow path provided inside the case is adjusted by sliding the slide damper.

Since the slide damper slides, an opening of a flow path provided in an interior of the case is adjusted.

(2) In addition, the slide damper device may be configured as follows: the slide damper device further comprises a shield wall shielding a fluid, the shield wall being provided at a side of a moving range of the connection member along the moving range.
(3) In addition, the slide damper device may be configured as follows: the connection member is provided at a side end part of the slide damper along an entire area in a direction in which the slide damper slides.
(4) In addition, the slide damper device may be configured as follows: a plurality of connection members are provided at the side end part of the slide damper in a direction in which the slide damper slides. The plurality of connection members are positioned while being distanced from one another.
(5) In addition, the slide damper device may be configured as follows: a thickness of the connection member is smaller than a thickness of the guide rail.

According to the above embodiment of the present invention, a plate-like guide rail is provided on an inner wall of a case instead of a guide groove which was provided in a conventional slide damper device. In addition, according to the above embodiment of the present invention, a concave shaped connection member is provided on a side end part of a slide damper.

First of all, according to an aspect of the present invention, the concave shaped connection member is provided to a slide damper which is smaller and has a simpler shape compared to the case. Therefore, the connection member may be manufactured with a high degree of dimensional precision. Hence, a gap between a guide rail and a connection member may easily be made smaller compared to a gap between a connection member and a guide groove in conventional slide damper devices. As a result, it is possible to prevent a leakage of a fluid from an upstream of a slide damper to a downstream.

Further, according to an aspect of the present invention, a guide rail and a case may be integrated. In addition, a connection member and a slide damper may be integrated. Therefore, it is possible to prevent the number of components of an air conditioning device for a vehicle from increasing.

Therefore, according to an aspect of the present invention, a leakage of a fluid from an upstream of a slide damper to a downstream can be prevented without increasing the number of components of an air conditioning device for a vehicle.

(6) By the way, a slide damper device according to an aspect of the present invention adjusts an opening of a flow path provided inside a case of an air conditioning device for a vehicle by sliding a slide damper. The slide damper comprises a guide provided on an inner wall of the case; a connection member provided at a side end part of the slide damper, the connection member slidably fitting with the guide, the connection member connecting the slide damper to the guide; and a protrusion member provided on either one of a sliding surface of the connection member with respect to the guide and a sliding surface of the guide with respect to the connection member. Here, the connection member and the guide slide against each other.
(7) The above slide damper device may be configured as follows: the protrusion member is provided on the sliding surface of the guide.
(8) The above slide damper device may be configured as follows: a plurality of the protrusion members are aligned while being separated from each other at a distance such that the sliding surface of the connection member is constantly contacting a plurality of the protrusion members.
(9) The above slide damper device may be configured as follows: a set of opposing surfaces comprised by the guide or the connection member are each regarded as the sliding surface. Here, the protrusion member is provided on each of the sliding surface. The protrusion member provided on each of the sliding surface are positioned to be out of alignment in a direction in which the slide damper slides.
(10) The above slide damper device may be configured as follows: a surface of the protrusion member is shaped as an arc warped towards a direction in which the slide damper slides.
(11) The above slide damper device may be configured as follows: the guide is a plate-like guide rail, and the connection member has a concave shape fitting with the guide rail.

According to the above embodiment of the present invention, a connection member and a guide slide against each other, and a protrusion member is provided on either of a sliding surface of the connection member with respect to the guide or a slide surface of the guide with respect to the connection member. Due to this protrusion member, the sliding surfaces, which slide against each other, are prevented from coming into contact with each other in their entirety. Therefore, the size of the area at which the connection member and the guide come in contact with each other may be reduced.

Therefore, according to the above embodiment of the present invention, it is possible to reduce the frictional resistance which occurs between the sliding surfaces which slide against each other. Thus, it is possible to allow a slide damper to slide smoothly.

(12) By the way, a slide damper device according to an aspect of the present invention adjusts an opening of a flow path provided inside a case of an air conditioning device for a vehicle by sliding a slide damper. The slide damper device comprises a guide provided on an inner wall of the case; a connection member provided at a side end part of the slide damper, the connection member slidably fitting with the guide, the connection member connecting the slide damper to the guide; and a plurality of sliding members comprising a first sliding surface of the connection member with respect to the guide and a second sliding surface of the guide with respect to the connection member. Here, the connection member and the guide slide against each other. The first sliding surface of each of the sliding members or the second sliding surface of each of the sliding members are slanted.
(13) The above slide damper device may be configured as follows: the guide is a plate-like guide rail, and the connection member has a concave shape fitting with the guide rail.
(14) The above slide damper device may be configured as follows: the first sliding surface of the connection member with respect to the guide is slanted.
(15) The above slide damper device may be configured as follows: a first separating distance between a first tip of the guide rail at a side of the slide damper and the connection member positioned forward from the first tip is smaller than a second separating distance between a second tip of the connection member at a side of the case and the case positioned forward from the second tip.

According to the above embodiment of the present invention, a connection member and a guide slide against each other. A sliding member comprises a sliding surface of the connection member with respect to the guide and a sliding surface of the guide with respect to the connection member. Considering the entirety of the sliding member, either one of the sliding surface is slanted. When either one of the sliding surface of the sliding member is slanted, the size of the area at which the sliding surfaces slide against each other decreases. As a result, it is possible to reduce an area of contact between the connection member and the guide.

Therefore, according to the above embodiment of the present invention, it is possible to reduce the frictional resistance which occurs between the sliding surfaces which slide against each other. Thus, it is possible to allow a slide damper to slide smoothly.

### BRIEF DESCRIPTION OF THE DRAWINGS

FIG. 1 is a perspective view showing a configuration of a slide damper device according to a first embodiment of the present invention.

FIG. 2 is a cross sectional view along line A-A in FIG. 1 according to a first embodiment of the present invention.

FIG. 3 is a modeled diagram of a cross section obtained by cutting a slide damper according to a second embodiment of the present invention at the same position as line A-A in FIG. 1.

FIG. 4 is a modeled diagram showing a first variation of a connection member comprised by a slide damper device according to a second embodiment of the present invention.

FIG. 5 is a modeled diagram showing a second variation of a connection member comprised by a slide damper device according to a second embodiment of the present invention.

FIG. 6 is a perspective view showing a configuration of a slide damper device according to a third embodiment of the present invention.

FIG. 7 is a perspective view showing a portion of a guide rail comprised by a slide damper device according to a third embodiment of the present invention.

FIG. 8 is a cross sectional view along line A100-A100 in FIG. 6 according to a third embodiment of the present invention.

FIG. 9 is a modeled diagram of a cross section obtained by cutting a slide damper according to a fourth embodiment of the present invention at the same position as line A100-A100 in FIG. 6.

FIG. 10 is a modeled diagram showing a variation of a slide damper device according to a fourth embodiment of the present invention.

FIG. 11 is a perspective view showing a configuration of a slide damper device according to a fifth embodiment of the present invention.

FIG. 12 is a cross sectional diagram along line A200-A200 in FIG. 11 according to a fifth embodiment of the present invention.

FIG. 13 is an enlarged cross sectional diagram including a connection member comprised by a slide damper device according to a fifth embodiment of the present invention.

FIG. 14 is a cross sectional view showing a variation of a slide damper device according to a fifth embodiment of the present invention.

FIG. 15 is a modeled diagram of a cross section obtained by cutting a slide damper according to a sixth embodiment of the present invention at the same position as line A200-A200 in FIG. 11.

FIG. 16 is a cross sectional view showing a variation of a slide damper device according to a sixth embodiment of the present invention.

### DETAILED DESCRIPTION OF THE PREFERRED EMBODIMENTS

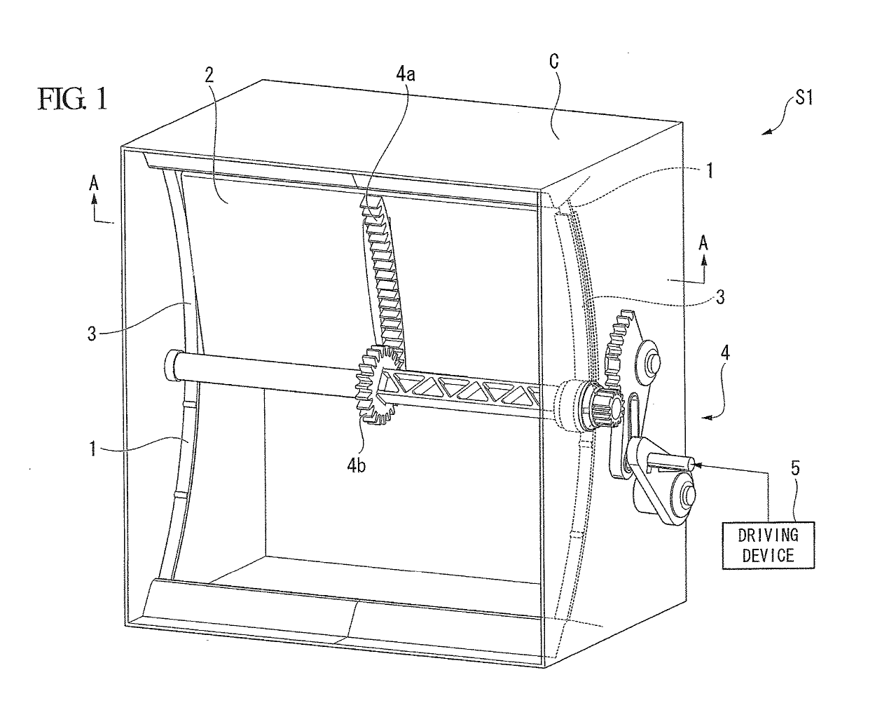

Hereunder, an aspect of a slide damper device according to the present invention is described with reference to FIGS. 1-16. In the diagrams, the scaling of some of the components are altered if necessary so that the components can be easily viewed.

The following description aims to provide a detailed explanation to facilitate an understanding of a gist of the present invention. Therefore, the present invention is not limited by the following description unless otherwise specifically noted.

### First Embodiment

Hereunder, a first embodiment of the present invention is described. FIG. 1 is a perspective view showing a configuration of a slide damper device 51 according to the present embodiment. Incidentally, in FIG. 1, the configuration of the front and back areas of the slide damper S1 are not diagramed, for purpose of enhancing visibility.

The slide damper S1 according to the above embodiment is used as an air mixing damper device which adjusts the ratio with which cold air and warm air is mixed, and an internal/external air swiching damper device which switches between a state of introducing external air and a state of circulating internal air. As shown in FIG. 1, the slide damper device S1 according to the present embodiment is placed at an interior part of a case C of an air conditioning device for a vehicle. The slide damper device S1 adjusts an opening of a flow path provided at an interior of the case.

Further, as indicated in FIG. 1, the slide damper device S1 according to the present embodiment comprises a guide rail 1, a slide damper 2, a connection member 3, a slide mechanism 4, and a driving device 5.

The guide rail 1 guides a movement of the slide damper 2. This guide rail 1 is shaped to be planar. The guide rail 1 is provided on an inner wall of the case C so as to extend in a direction in which the slide damper 2 slides.

Further, the guide rail 1 is provided on both sides of the slide damper 2 so as to sandwich the slide damper. Each guide rail 1 is curved according to a moving range of the slide damper 2 in an extending direction. However, two guide rails 1 are similarly curved in an extending direction so that the two guide rails are constantly parallel to each other.

The slide damper 2 is connected to the guide rail 1 via the connection member 3. The slide damper 2 may move along the guide rail 1.

The slide damper 2 is configured so that the slide damper 2 can slide between a plurality of openings of a flow path provided in parallel at a downstream side of the slide damper 2. The slide damper 2 adjusts the opening of the flow path by adjusting how much the opening of the flow path is opened in accordance with a sliding position.

The connection member 3 connects the slide damper 2 to the guide rail 1.

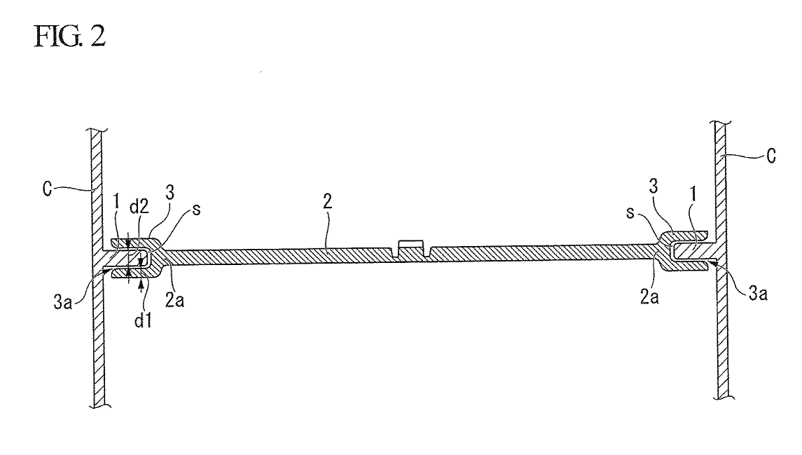

FIG. 2 is a diagram showing a cross sectional view along line A-A of FIG. 1. As shown in this diagram, the connection member 3 is provided on a side end part 2a of the slide damper 2. The connection member 3 is concaved shaped, so that the connection member 3 can fit to the guide rail 1. In particular, the connection member 3 is concaved shaped by comprising a groove part 3a to which the guide rail 1 can fit.

Further, both ends of the groove part 3a are open ends. Thus, the connection member 3 is fitted to the guide rail 1 so that the connection member 3 may slide in a direction in which the guide rail 1 extends.

Moreover, according to the slide damper device S1 based on the present embodiment, the connection member 3 is provided on all areas of the side end part 2a of the slide damper 2 at a guide rail 1 side, as shown in FIG. 1.

In addition, as shown in FIG. 2, the thickness d1 of the connection member 3 is set to be smaller than the thickness d2 of the guide rail 1.

Returning to FIG. 1, the slide mechanism 4 provides power to the slide damper 2 for moving the slide damper 2. This slide mechanism 4 comprises a rack gear 4a provided on the slide damper 2, a pinion gear 4b interlocking with the rack gear 4a, a cam and a middle gear placed between the pinion gear 4b and a driving device 5, and the like.

The driving device 5 transmits power to the slide damper 2 via the slide mechanism 4 for moving the slide damper 2. For example, a motor is used as the driving device 5.

According to the slide damper device S1 configured as described above based on the present embodiment, when air (fluid) is supplied from an upstream side, this air is divided and supplied to a plurality of flow paths at a downstream side according to the position of the slide damper 2.

According to the slide damper device S1 based on the present embodiment, a plate-like guide rail 1 is provided on an inner wall of the case C, instead of a guide groove which was provided in conventional devices. Further, according to the slide damper device S1 based on the present embodiment, a concave shaped connection member 3 is provided on a side end part 2a of the slide damper 2.

First, according to the slide damper device S1 based on the present embodiment, the concave shaped connection member 3 is provided on a slide damper which is smaller and is shaped more simply compared to the case C. As a result, the connection member 3 may be manufactured with a high degree of dimensional precision by, for example, an injection molding.

Therefore, according to the slide damper device S1 based on the present embodiment, it is possible to reduce the width of the gap between the guide rail 1 and the connection member 3 more easily compared reducing the width of a gap between a connection member and a guide groove of conventional devices. Further, according to the slide damper device S1 based on the present embodiment, the gap s between the guide rail 1 and the connection member 3 is set to be smaller than a gap between a connection member and a guide groove of conventional devices.

Hence, according to the slide damper device S1 based on the present embodiment, it is possible to prevent a flowing out of a fluid from an upstream of the slide damper 2 to a downstream.

Further, according to the slide damper device S1 based on the present embodiment, the guide rail 1 may be integrated with the case C, and the connection member 3 may be integrated with the slide damper 2 by injection molding. Therefore, it is possible to prevent an increase in the number of components of an air conditioning device for a vehicle.

As described above, according to the slide damper device S1 based on the present embodiment, a leakage of a fluid from an upstream of the slide damper 2 to a downstream can be prevented without increasing the number of components of an air conditioning device for a vehicle.

Further, according to the slide damper device S1 based on the present embodiment, the connection member 3 is provided along the entire area of the side end part 2a of the slide damper 2 in a direction in which the slide damper 2 slides.

Therefore, for the entire length of the slide damper 2 in the sliding direction, leakage of air can be prevented.

Further, according to the slide damper device S1 based on the present embodiment, the thickness of the connection member 3 is set to be smaller than the thickness d2 of the guide rail 1.

As a result, it is possible to reduce the amount of resin necessary to form the connection member 3, thereby reducing the mass of the connection member 3. Hence, it is possible to easily move the slide damper 2 in a smooth manner. Further, since the amount of resin necessary for forming the connection member 3 decreases, it is possible to reduce the manufacturing cost of the connection member 3 (i.e., the slide damper 2).

### Second Embodiment

Next, a second embodiment of the present invention is described. In the present embodiment, components which are similar to that of the first embodiment are not described or are described only briefly.

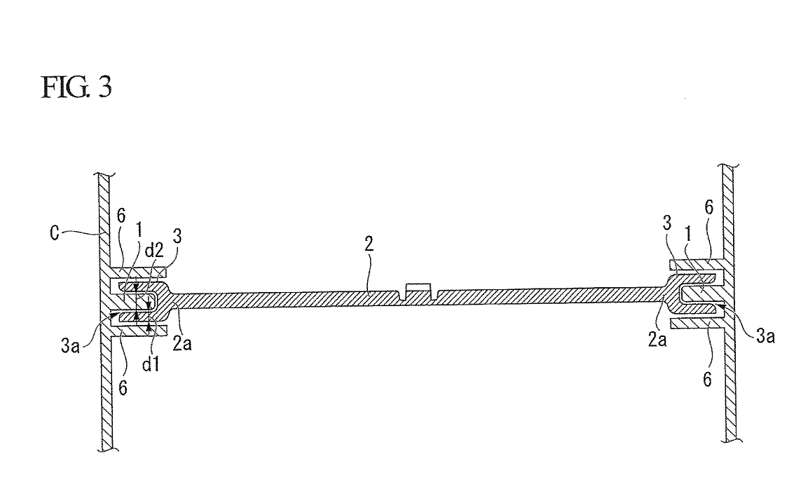

FIG. 3 is a modeled diagram of a cross section obtained by cutting a slide damper according to the present embodiment at the same position as line A-A in FIG. 1.

As shown in FIG. 3, the slide damper device according to the present embodiment comprises a shield wall 6 which shield an air flow and is placed at both sides of a moving range of the connection member 3. The shield wall 6 is placed along the moving range of the connection member 3. The shield wall 6, placed at an upstream side of the slide damper 2, shields air which is about to flow in the gap s between the guide rail 1 and the connection member 3. Further, the shield wall 6, placed at a downstream side of the slide damper 2, shields air leaking from the gap s between the guide rail 1 and the connection member 3.

By providing the shield wall 6 as described above, it becomes difficult for air to pass through the gap s between the guide rail 1 and the connection member 3. As a result, the leakage of the air from the upstream of the slide damper 2 to the downstream may be better restrained.

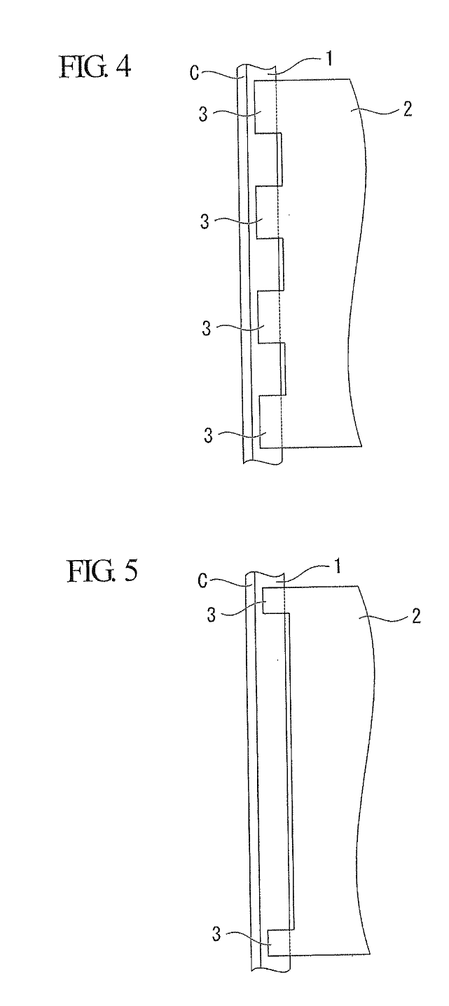

Incidentally, when the leakage of the air from the upstream of the slide damper 2 to the downstream may be better restrained by providing the shield wall 6, a plurality of connection members 3 may be provided on a side end part 2a of the slide damper 2 in a direction in which the slide damper 2 slides, as indicated in FIG. 4 (a modeled diagram showing a first variation of the connection member 3) for instance.

In such an instance, the amount of air leaking from between the connection members 3 increases. However, because the shield wall 6 restrains the leakage of the air, it is possible to adequately prevent a leakage of the air. Further, by providing a plurality of connection members 3 placed at a distance from one another, the total mass of the connection member 3 decreases. In addition, it becomes possible to provide a smooth movement of the slide damper 2 more easily.

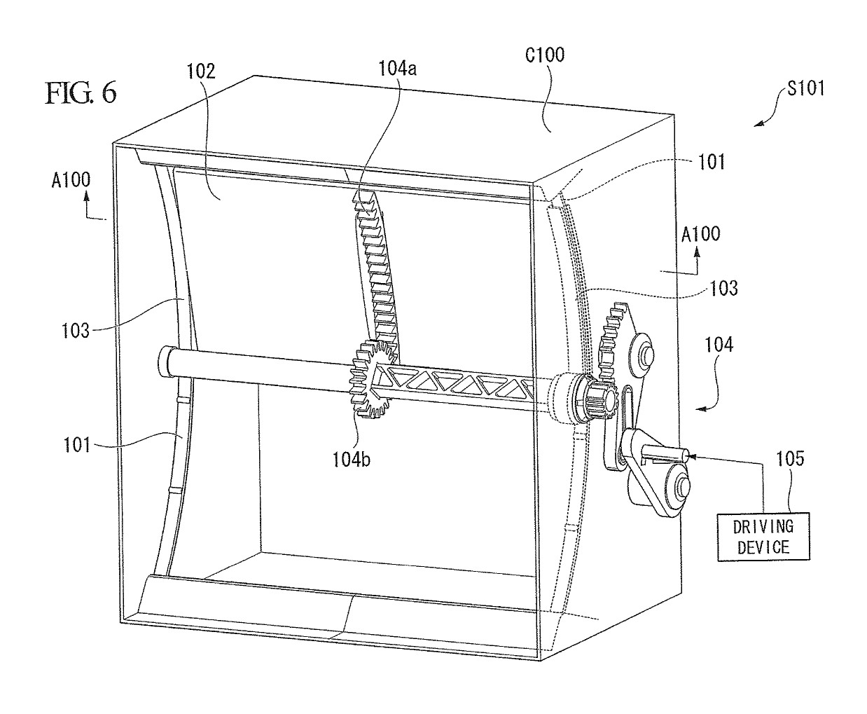

Further, as indicated in FIG. 5 (a modeled diagram showing a second variation of the connection member 3), the connection member 3 may be provided only at an end part of the slide damper 2 in the sliding direction.

As a result, the total mass of the connection member 3 decreases. Further, it becomes possible to move the slide damper 2 smoothly more easily.

In addition, when the connection member 3 is provided only at an end part of the slide damper 2 in the sliding direction, a component of the connection member 3 which tucks down the guide rail 1 may be shaped as a cylinder, and an area of contact between the connection member 3 and the guide rail 1 may be reduced. As a result, it is possible to move the slide damper 2 more smoothly.

Incidentally, a configuration in which a plurality of the connection members 3, shown in FIG. 4, are provided at a side end part 2a of the slide damper 2 in the sliding direction of the slide damper 2, and a configuration in which a connection member 3, shown in FIG. 5, is only provided at an end part of the slide damper 2 in the sliding direction may be used in an instance as in the first embodiment when the shield wall 6 is not provided.

Further, according to the first embodiment, the slide damper 2 was configured to be curved, as in FIG. 1.

However, the present invention is not limited to this configuration. The slide damper may be configured to be planar as well.

### Third Embodiment

Next, a third embodiment of the present invention is described. FIG. 6 is a perspective view showing a configuration of a slide damper device S101 according to the present embodiment. Incidentally, in FIG. 6, the areas in the front and back of the slide damper device S101 are not diagramed in order to enhance visibility.

Further, because a slide damper device S101, a case C100, a guide rail 101, a slide damper 102, a connection member 103, a slide mechanism 104, and a driving device 105 are configured to be similar to those of the first and second embodiments, a detailed description of the components are omitted.

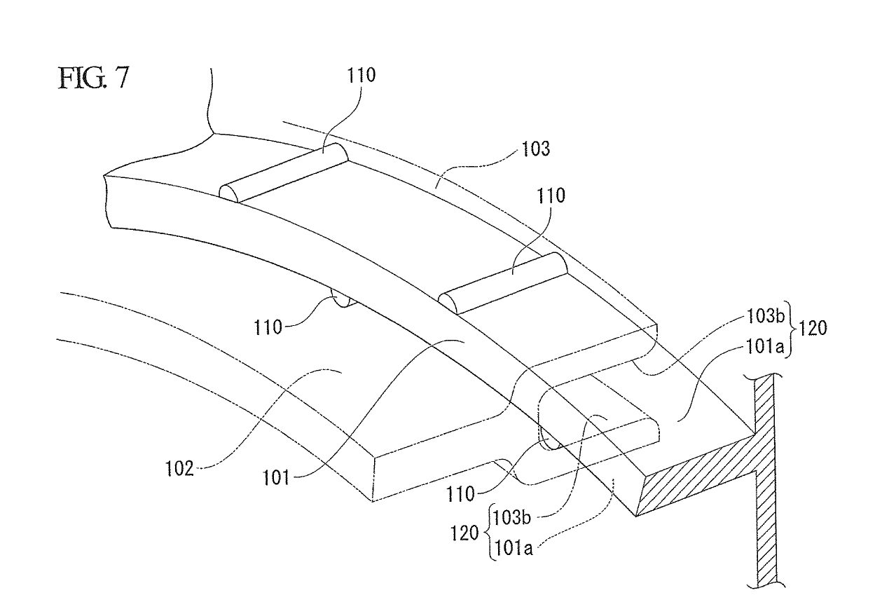

FIG. 7 is a perspective view showing a part of the guide rail 101.

As shown in FIG. 7, a plurality of protrusion members 110 are provided on both surfaces 101a of the guide rail 101. The plurality of protrusion members 110 are aligned in a direction in which the guide rail 101 extends. Here, the surface 101a of the guide rail 101 is regarded as a sliding surface with respect to the connection member 103. In other words, according to the slide damper device S101 based on the present embodiment, the protrusion member 110 is provided on a sliding surface of the guide rail 101 with respect to the connection member 103.

Each of the protrusion members 110 is shaped as a semicircular column. A circumferential surface of each of the protrusion members 110 is placed so as to face the side of the moving range of the connection member 103, described later in detail, so that the shape of the surface becomes an arc in a direction in which the slide damper 102 slides (a direction in which the guide rail 101 extends).

Incidentally, a gloss is applied on a surface 101a of the guide rail 101. Thus, a configuration is made so that the connection member 103 moves smoothly.

Further, according to the slide damper device S101 based on the present embodiment, the surface 101a of the guide rail 101 is configured to be a sliding surface with respect to the connection member 103. Further, a protrusion member 110 is provided with respect to a surface 101a of the guide rail 101. In other words, according to the slide damper device S101 based on the present embodiment, both sides of the guide rail 101 facing each other are regarded as sliding surfaces, and a protrusion member 110 is provided on both of these sliding surfaces.

Moreover, as shown in FIG. 7, according to the slide damper device S101 based on the present embodiment, a protrusion member 110 provided on a sliding surface of one side of the guide rail 101 and a protrusion member 110 provided on a sliding surface of the other side of the guide rail 101 are placed out of alignment with each other in a sliding direction of the slide damper 102 (i.e., a direction in which the guide rail 101 extends). In other words, the protrusion member 110 is alternatively placed in a sliding direction of the slide damper 102 with respect to the opposing front and back surfaces (i.e., the sliding surfaces) of the guide rail 101.

Incidentally, as shown in FIG. 7, the distance with which the protrusion members 110 are placed from each other at one surface 101a of the guide rail 101 is set to be a distance such that the sliding surface of the connection member 103 (a surface of the connection member 103 which slides with respect to the surface 101a of the guide rail 101) is constantly in contact with two or more (a plurality of) protrusion members 110.

Returning to FIG. 6, the slide damper 102 is connected to the guide rail 101 via the connection member 103. The slide damper 102 may move along the guide rail 101.

This slide damper 102 is configured so that the slide damper 102 may slide between a plurality of flow path openings which are provided in parallel at a downstream side of the slide damper 102. Here, a “flow path opening” refers to “an opening of a flow path.” The opening of the flow path is adjusted by adjusting how much each flow path opening is opened in accordance with a sliding position.

The connection member 103 connects the slide damper 102 to the guide rail 101.

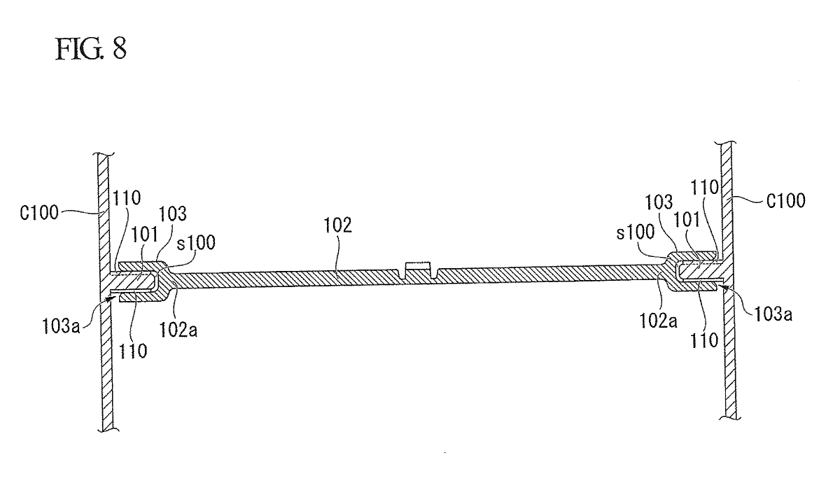

FIG. 8 is a diagram showing a cross section along line A100-A100 in FIG. 6. As shown in FIG. 8, the connection member 103 is provided on a side end part 102a of the slide damper 102, and is concave shaped so that the connection member 103 can fit with the guide rail 101. In particular, the connection member 103 is concave shaped by comprising a groove portion 103a which can be fitted to a guide rail 101.

Further, both ends of the groove portion 103 in the sliding direction are open ends. Thus, the connection member 103 may freely slide with respect to the guide rail 101 in a direction in which the guide rail 101 extends. As a result, each of an inner wall surface 103b of the groove portion 103a of the connection member 103 tucking in the guide rail 101 is regarded as a sliding surface which slides with respect to the guide rail 101.

Incidentally, according to the slide damper device 5101 based on the present embodiment, the connection member 103 is provided on an entire area of the side end part 102a of the slide damper 102 at a side of the guide rail 101, as shown in FIG. 6.

Returning to FIG. 6, the slide mechanism 104 provides power to the slide damper 102 for moving the slide damper 102. This slide mechanism 104 comprises a rack gear 104a provided on the slide damper 102, a pinion gear 104b interlocking with the rack gear 104a, a cam and a middle gear placed between the pinion gear 104b and a driving device 105, and the like.

The driving device 105 transmits power to the slide damper 102 via the slide mechanism 104 for moving the slide damper 102. For example, a motor is used as the driving device 105.

In this way, according to the slide damper device S101 based on the present embodiment, when one sliding member 120 is regarded to comprise a sliding surface of the guide rail 101 with respect to the connection member 103 (i.e., the surface 101a of the guide rail 101) and a sliding surface of the guide rail 101 with respect to the connection member 103 (i.e., the inner wall surface 103b of the connection member 103), the slide damper device S101 comprises four sliding members 120. The sliding surfaces slide against each other. Further, a protrusion member 110 is provided on a surface 101a of the guide rail 101, with respect to each of the sliding members 120.

Further, according to the slide damper device S101 based on the present embodiment, when air (fluid) is supplied from an upstream side, this air is divided and supplied to a plurality of flow paths at a downstream side according to the position of the slide damper 102.

In this way, according to the slide damper device S101 based on the present embodiment, a protrusion member 110 is provided on the surface 101a of the guide rail 101. As a result, the sliding surfaces (the surface 101a of the guide rail 101 and the inner wall surface 103b) which are sliding against one another are prevented from contacting each other in their entirety. As a result, it is possible to reduce the area of contact between the connection member 103 and the guide rail 101.

Therefore, according to the present invention, it is possible to reduce the frictional resistance created between the sliding surfaces which are sliding against each other. Accordingly, the slide damper 102 may be moved smoothly.

Moreover, a gloss is applied to a surface 101a of the guide rail 101 as described above. The gloss applied to the surface 101a of the guide rail 101 is gradually pushed out from the sliding area of the connection member 103 by the sliding of the connection member 103 with respect to the guide rail 101. When the amount of gloss in the sliding area of the connection member 103 greatly decreases, the slide damper 102 is prevented from moving smoothly.

Meanwhile, the protrusion member 110 comprised by the slide damper device S101 based on the present embodiment protrudes with respect to the surface 101a of the guide rail 101. Therefore, it is possible to hold the gloss that moves due to the sliding of the connection member 103. In other words, the protrusion member 110 comprised by the slide damper device S101 based on the present embodiment operates as a gloss pool. As a result, according to the slide damper device S101 based on the present embodiment, it is possible to hold the gloss for a long period of time to the sliding area of the connection member 103. Thus, the slide damper 102 may move smoothly for a long period of time.

In addition, according to the slide damper device S101 based on the present embodiment, the protrusion member 110 is provided on a sliding surface (i.e., the surface 101a) of the guide rail 101.

Therefore, compared to an instance in which the protrusion member 110 is provided at an inner wall surface 103b of the connection member 103, a greater number of protrusion members 110 may be placed.

Hence, it is possible to provide a large number of gloss pools described above. Thus, the slide damper 102 may move smoothly for a longer period of time.

Further, according to the slide damper device S101 based on the present embodiment, the protrusion member 110 is aligned so that a sliding surface of the connection member 103 (i.e., a surface of the connection member 103 which slides with respect to the surface 101a of the guide rail 101) always comes in contact with two or more (a plurality of) protrusion members 110.

Therefore, the connection member 103 may always be supported stably in a sliding direction of the slide damper 102. Thus, the slide damper 102 may be moved smoothly.

Further, according to the slide damper device S101 based on the present embodiment, a protrusion member 110 provided on a sliding surface of one side of the guide rail 101 and a protrusion member 110 provided on a sliding surface of the other side of the guide rail 101 are placed out of alignment with each other in a sliding direction of the slide damper 102 (i.e., a direction in which the guide rail 101 extends). In other words, the protrusion member 110 is alternatively placed in a sliding direction of the slide damper 102 with respect to the opposing front and back surfaces (i.e., the sliding surfaces) of the guide rail 101.

Therefore, when the protrusion member 110 is pressed strongly from the connection member 103, there is no protrusion member 110 which presses from an opposite side a portion of the guide rail 101 at which the protrusion member 110 is placed. Therefore, the portion of the guide rail 101 may be deformed. Consequently, it is possible to change the position of the protrusion member 110 in a direction of the thickness of the guide rail 101. Therefore, even in an instance in which the guide rail 101, the connection member 103, and the protrusion member 110 includes a dimension error and is pressed strongly from the connection member 103, the slide damper 102 continues to move smoothly.

### Fourth Embodiment

Next, a fourth embodiment of the present invention is described. Components of the present embodiment which are similar to those of the third embodiment are not described or described only briefly.

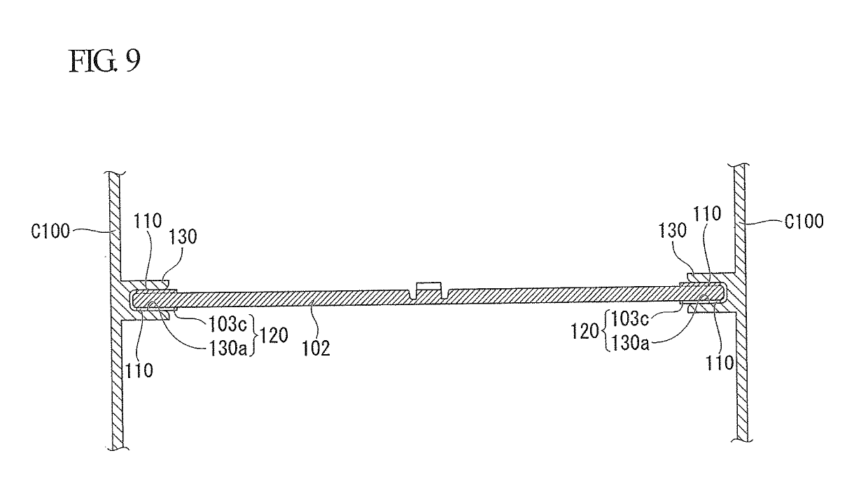

FIG. 9 is a modeled diagram of a cross section obtained by cutting a slide damper according to the present embodiment at the same position as line A100-A100 in FIG. 6.

As shown in FIG. 9, the slide damper device according to the present embodiment comprises a guide groove 130 (hereinafter may be referred to as a “guide”) provided at an inner wall of the case C100, instead of the guide rail 101 according to the third embodiment described above.

Further, according to the slide damper device based on the present embodiment, the connection member 103 is shaped in a protruding manner so as to fit with the guide groove 130. Incidentally, the connection member 103 may be provided along the entire area of the side end part 102a of the slide damper 102 in the sliding direction. In addition, the connection member 103 may be provided only at a tip portion in the sliding direction in a pin-like manner.

Further, according to the slide damper device based on the present embodiment, a plurality of protrusion members 110 are provided on an inner wall surface 130a (sliding surface) of the guide groove 130.

According to a slide damper device based on the present embodiment employing the configuration described above, due to the protrusion member 110, the sliding surfaces (the inner wall surface 130a of the guide groove 130 and the surface 103c of the connection member 103) which are sliding against one another are prevented from contacting each other in their entirety. As a result, it is possible to reduce the area of contact between the connection member 103 and the guide groove 130.

Therefore, according to the present embodiment, it is also possible to reduce the frictional resistance created between the sliding surfaces which are sliding against each other. Accordingly, the slide damper 102 may be moved smoothly.

In the present embodiment, a configuration was describe in which a protrusion member 110 is provided at a side of the guide (i.e., the guide rail 101 or the guide groove 130) with respect to all of the sliding members.

However, the present invention is not limited to this configuration. A protrusion member may be provided to a side of the connection member 103.

In addition, it is not necessary that a protrusion member be provided on all of the sliding members.

For example, a protrusion member may be provided only on a sliding member placed at a downstream side of the slide damper 102. Since the slide damper 102 is pushed towards the downstream side due to an air flow, the slide damper 102 may be moved smoothly in a more efficient manner by placing the protrusion member at a sliding member at a downstream side compared to placing the protrusion member at an upstream side. Therefore, even if the protrusion member is provided only at a sliding member placed at a downstream side of the slide damper 102, it is possible to make the movement of the slide damper 102 sufficiently smooth. Moreover, since a protrusion member is not provided at a sliding member at an upstream side, it is possible to lower the cost of the sliding damper.

In addition, the protrusion member may be provided only at a sliding member placed at an upstream side of the slide damper 102. In this instance, the slide damper 102 is pushed towards the downstream side by an air flow. As a result, the connection member and the guide come in close contact with each other. Therefore, it is possible to prevent leakage of the air from the upstream of the slide damper 102 towards the downstream. Even in this instance, a protrusion member is provided at a sliding member at the upstream side. Therefore, the slide damper 102 may be moved compared to conventional devices.

Further, according to the third embodiment, a configuration was described in which the slide damper 102 was curved as shown in FIG. 6.

However, the present invention is not limited to this configuration. It is possible to employ a configuration in which a planar slide damper is used.

Further, according to the fourth embodiment, a configuration was described in which the guide groove 130 is provided on an inner wall surface of the case C100 so as to protrude towards an interior of the case C100.

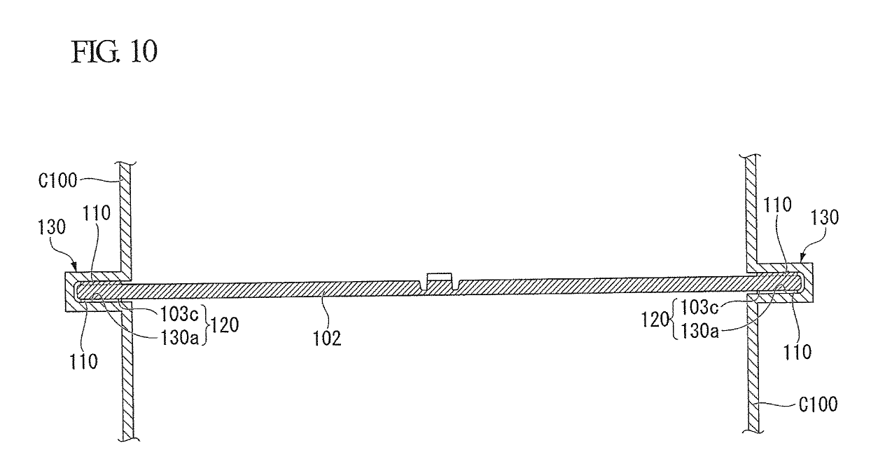

However, the present invention is not limited to this configuration. As shown in FIG. 10, a configuration may be employed in which the guide groove 130 is provided on an inner wall surface of the case C100 so as to protrude towards an exterior of the case C100.

### Fifth Embodiment

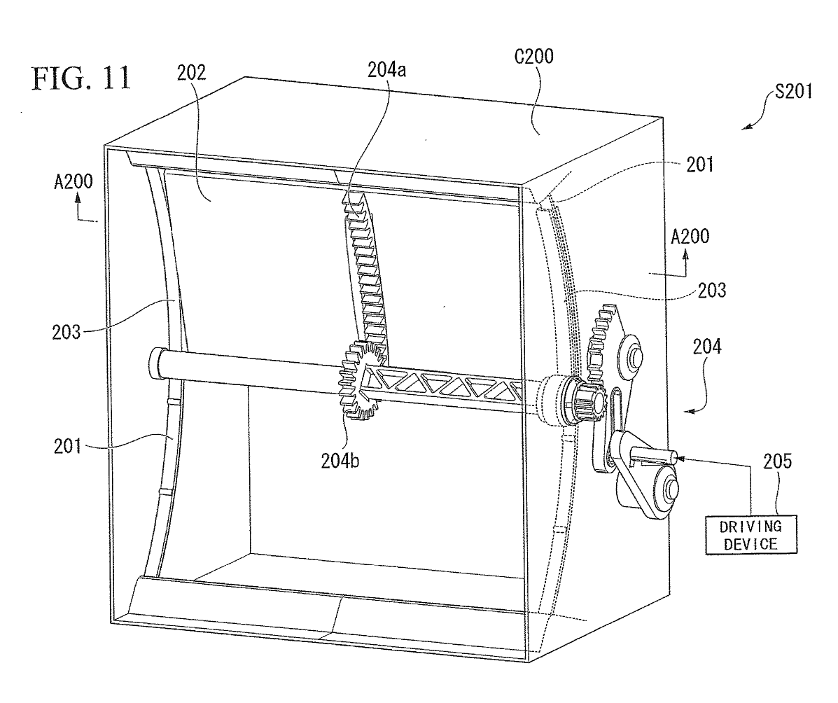

Hereinafter, a fifth embodiment of the present invention is described. FIG. 11 is a perspective view showing a configuration of a slide damper device 5201 according to the present embodiment. Incidentally, in FIG. 11, the areas in the front and back of the slide damper device S201 are not diagramed in order to enhance visibility.

Further, because a slide damper device 5201, a case C200, a guide rail 201, a slide damper 202, a connection member 203, a slide mechanism 204, and a driving device 205 are configured to be similar to those of the embodiments described earlier, a detailed description of the components are omitted.

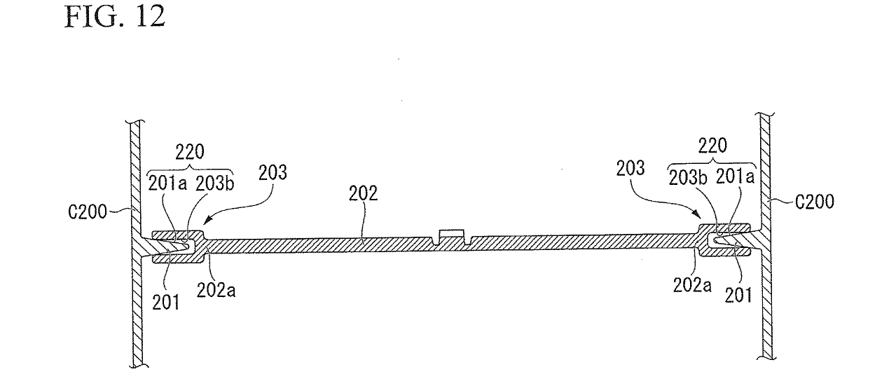

FIG. 12 is a cross sectional diagram along line A200-A200 in FIG. 11. As shown in FIG. 12, the connection member 203 is provided on a side end part 202a of the slide damper 202, and is concave shaped so that the connection member 203 can fit with the guide rail 201. In particular, the connection member 203 is concave shaped by comprising a groove portion 203a which can be fitted to a guide rail 201.

Further, both ends of the groove portion 203 in the sliding direction are open ends. Thus, the connection member 203 may freely slide with respect to the guide rail 201 in a direction in which the guide rail 201 extends. As a result, each of an inner wall surface 203b of the groove portion 203a of the connection member 203 tucking in the guide rail 201 is regarded as a sliding surface which slides with respect to the guide rail 201.

Incidentally, according to the slide damper device 5201 based on the present embodiment, the connection member 203 is provided on an entire area of the side end part 202a of the slide damper 202 at a side of the guide rail 201, as shown in FIG. 11.

Returning to FIG. 11, the slide mechanism 204 provides power to the slide damper 202 for moving the slide damper 202. This slide mechanism 204 comprises a rack gear 204a provided on the slide damper 202, a pinion gear 204b interlocking with the rack gear 204a, a cam and a middle gear placed between the pinion gear 204b and a driving device 205, and the like.

The driving device 205 transmits power to the slide damper 202 via the slide mechanism 204 for moving the slide damper 202. For example, a motor is used as the driving device 205.

In this way, according to the slide damper device S201 based on the present embodiment, when one sliding member 220 is regarded to comprise a sliding surface of the guide rail 201 with respect to the connection member 203 (i.e., the surface 201a of the guide rail 201) and a sliding surface of the guide rail 201 with respect to the connection member 203 (i.e., the inner wall surface 203b of the connection member 203), the slide damper device S201 comprises four sliding members 220. The sliding surfaces slide against each other.

Moreover, according to the slide damper device 5201 based on the present embodiment, a sliding surface of the connection member 203 with respect to the guide rail 201 (the inner wall surface 203b) is slanted with respect to a sliding surface of the guide rail 201 with respect to the connection member 203 (surface 201a), as shown the enlarged diagram in FIG. 13.

In more detail, the inner wall surface 203b of the connection member 203 is parallel to the surface of the slide damper 202. Meanwhile, as the surface 201a of the guide rail 201 extends towards the tip of the guide rail 201, a slanting is made so as to approach the slide damper 202. The guide rail 201 is shaped so that the front and back surfaces approach one another towards the tip of the guide rail 201. In other words, as shown in FIG. 13, the guide rail 201 is shaped so that the cross sectional area becomes smaller towards the tip of the guide rail 201.

Further, according to the slide damper device 5201 based on the present embodiment, the surface 201a of the guide rail 201 is slanted with respect to all of the sliding members 220. In other words, according to the slide damper device S201 based on the present embodiment, the sliding surface of the guide rail 201 with respect to the connection member 203 is slanted with respect to all of the sliding members 220.

Further, according to the slide damper device S201 based on the present embodiment, when the connection member 203 is fitted to the guide rail 201 as shown in FIG. 13, a separating distance d201 from the tip 201b of the slide damper 202 side of the guide rail 201 to the connection member 203 located ahead of the tip 201b is set to be smaller than a separating distance d202 from the tip 203c of the connection member 203 at a case C200 side to the case C200 positioned ahead of this tip 203c.

Further, according to the slide damper device S201 based on the present embodiment, when air (fluid) is supplied from an upstream side, this air is divided and supplied to a plurality of flow paths at a downstream side according to the position of the slide damper 202.

According to the slide damper device S201 based on the present embodiment, the surface 201a, which is a sliding surface of the guide rail 201, is slanted with respect to the entire sliding member 220 comprising a sliding surface of the connection member 203 with respect to the guide rail 201 (inner wall surface 203b) and a sliding surface of the guide rail 201 with respect to the connection member 203 (surface 201a) which are sliding against each other.

According to the sliding member 220, when the sliding surface of the guide rail 201 (surface 201a) is slanted, the inner wall surface 203b of the connection member 203 partially hits the surface 201a of the guide rail 201. As a result, the size of the area at which the sliding surfaces come into contact with each other decreases. As a result, it is possible to reduce the area in contact between the connection member 203 and the guide rail 201.

Therefore, according to the slide damper device S201 based on the present embodiment, it is possible to reduce the frictional resistance which occurs between the sliding surfaces which slide against each other. Thus, it is possible to allow a slide damper to slide smoothly.

Further, according to the sliding member 220, because the surface 201a of the guide rail 201 and the inner wall surface 203b of the connection member 203 are always sliding against one another, the surface 201a of the guide rail 201 and the inner wall surface 203b of the connection member 203 may wear out, thereby changing the condition in which the guide rail 201 and the connection member 203 are fitted against each other.

Therefore, according to the slide damper device S201 based on the present embodiment, the separating distance d201 from the tip 201b of the slide damper 202 side of the guide rail 201 to the connection member 203 located ahead of the tip 201b is set to be smaller than the separating distance d202 from the tip 203c of the connection member 203 at a case C200 side to the case C200 positioned ahead of this tip 203c.

Thus, according to the slide damper device S201 based on the present embodiment, when the connection member 203 and the case C200 becomes close to each other due to the wearing out described above, the tip 201b of the guide rail 201 comes in contact with the connection member 203 before the tip 203c of the connection member 203 contacts the case C200.

The number of the tip 201b of the guide rail 201 is one. Meanwhile, the number of the tip 203c of the connection member 203 is two. Therefore, the frictional resistance between the guide rail 201 and the connection member 203 is smaller in an instance in which the tip 201b of the guide rail 201 contacts the connection member 203 compared to an instance in which the tip 203c of the connection member 203 contacts the case C200. Therefore, according to the slide damper device S201 based on the present embodiment, even when the guide rail 201 and the connection member 203 are worn out by the passage of time, and even in an instance in which the guide rail 201 and the connection member 203 come in contact with one another at a portion that should not be contacted, it is possible to restrain the frictional resistance from increasing. Thus, it is possible to preserve the sliding motion of the slide damper 202.

Further, in order to prevent the surface 201a of the guide rail 201 and the inner wall surface 203b of the connection member 203 from wearing out, it is preferable that a surface removing operation be performed on a portion which hits the surface 201a of the guide rail 201 of the connection member 203.

Further, among the sliding surfaces (the surface 201a of the guide rail 201 and the inner wall surface 203b of the connection member 203) comprised by the sliding member 220, the present embodiment employs a configuration in which the sliding surface of the guide rail 201 (surface 201a) is slanted.

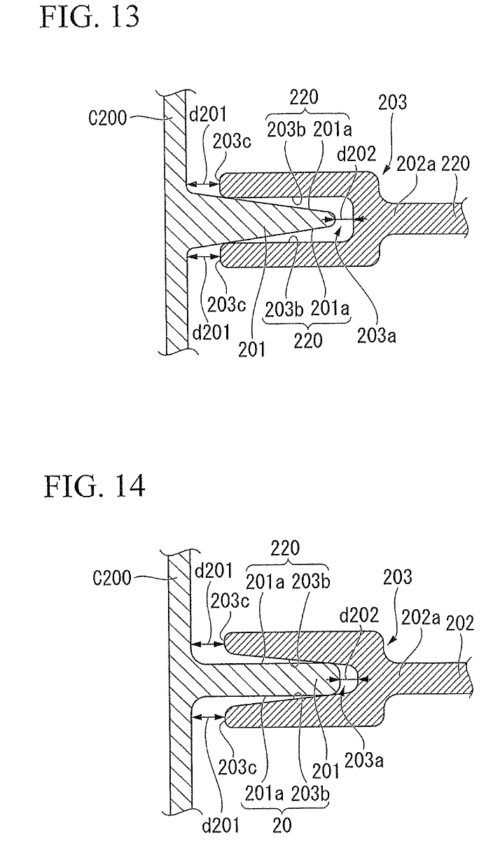

However, the present invention is not limited to this configuration. As shown in FIG. 14, it is possible to employ a configuration in which the surface 201a of the guide rail 201 is parallel to the surface of the slide damper 202, and the inner wall surface 203b of the connection member 203 is slanted with respect to the surface 201a of the guide rail 201.

Even if such a configuration is employed, it is possible to reduce the frictional resistance which occurs between the sliding surfaces which slide against each other, and it is possible to allow a slide damper to slide smoothly, as in the slide damper device S201 based on the present embodiment.

However, when a configuration shown in FIG. 14 is employed such that the inner wall surface 203b of the connection member 203 is slanted, the connection member 203 opens outwards towards the tip 203c.

When such a shape is employed, a wall unit 3d comprising the inner wall surface 203b of the connection member 203 is already facing outwards. Therefore, it is possible to alter the shape of the wall unit 3d towards the outer side.

On the other hand, as in the slide damper device S201 according to the present embodiment, among the sliding surfaces (the surface 201a of the guide rail 201 and the inner wall surface 203b of the connection member 203) comprised by the sliding member 220, a configuration is employed such that the sliding surface of the guide rail 201 (surface 201a) is slanted. As a result, the wall part 203d of the connection member 203 may be further deformed towards the outer side. Therefore, according to the slide damper device S201 based on the present embodiment, even if the sliding slide damper 202 moves towards the case C 200 side due to dimensional errors and the like, this movement is absorbed by the deformation of the wall part 203d of the connection member 203. As a result, it is possible to obtain a smooth movement of the slide damper 202.

### Sixth Embodiment

Next, a sixth embodiment of the present invention is described. In the present embodiment, components which are similar to that of the fifth embodiment are not described or are described only briefly.

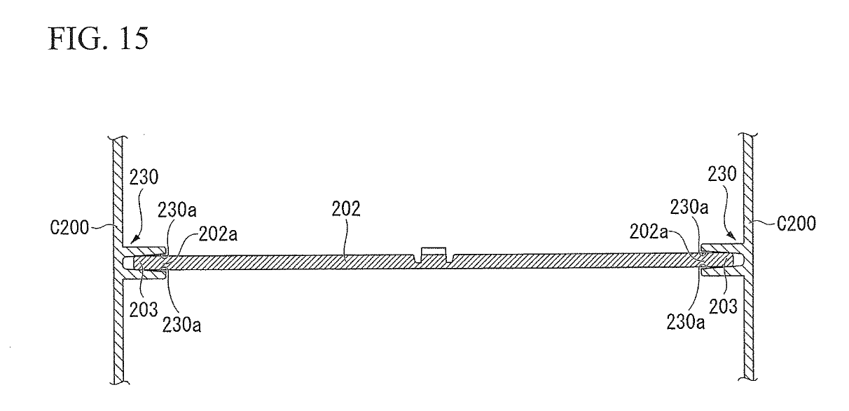

FIG. 15 is a modeled diagram of a cross section obtained by cutting a slide damper according to the present embodiment at the same position as line A200-A200 in FIG. 11.

As shown in FIG. 15, the slide damper device according to the present embodiment comprises a guide groove 230 (hereinafter may be referred to as a “guide”) provided at an inner wall of the case C200, instead of the guide rail 201 according to the fifth embodiment described above.

Further, according to the slide damper device based on the present embodiment, the connection member 203 is shaped in a protruding manner so as to fit with the guide groove 230. Incidentally, the connection member 203 may be provided along the entire area of the side end part 202a of the slide damper 202 in the sliding direction. In addition, the connection member 203 may be provided only at a tip portion in the sliding direction in a pin-like manner.

Further, according to the slide damper device based on the present embodiment, the inner wall surface 230a (sliding surface) of the guide groove 230 is slanted with respect to the connection member 203 which was parallel with respect to the surface of the slide damper 202.

According to the slide damper device based on the present embodiment, it is possible to reduce the area in contact between the connection member 203 and the guide rail 201, in a way similar to the fifth embodiment.

Therefore, according to the slide damper device based on the present embodiment, it is possible to reduce the frictional resistance created between the sliding surfaces which are sliding against each other. Accordingly, the slide damper may be moved smoothly.

Incidentally, according to the fifth embodiment, a configuration was described in which the slide damper 202 was curved as shown in FIG. 11.

However, the present invention is not limited to this configuration. It is possible to employ a configuration in which a planar slide damper is used.

Further, according to the sixth embodiment, a configuration was described in which the guide groove 230 is provided on an inner wall surface of the case C200 so as to protrude towards an interior of the case C200.

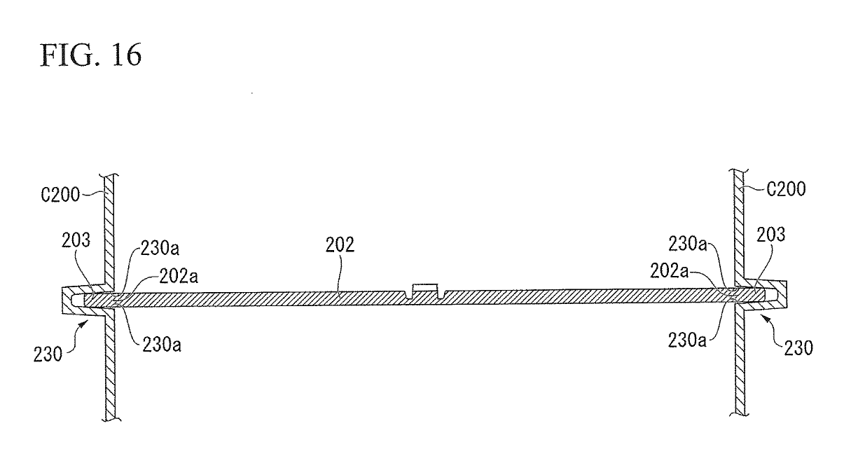

However, the present invention is not limited to this configuration. As shown in FIG. 16, a configuration may be employed in which the guide groove 230 is provided on an inner wall surface of the case C200 so as to protrude towards an exterior of the case C200.

While a preferred embodiment of the present invention has been described above, it should be understood that these are exemplary of the invention and are not to be considered as limiting the present invention. Additions, omissions, substitutions, and other modifications can be made without departing from the scope of the present invention. The invention is not to be considered as being limited by the foregoing description, and is only limited by the scope of the appended claims.

What is claimed is:

1. A slide damper device comprising:
a case of an air conditioning device for a vehicle;
a slide damper;
a plate-like guide rail provided on an inner wall of the case; and
a connection member provided at a side end part of the slide damper, the connection member having a concave shape slidably fitting with the guide rail, the connection member connecting the slide damper to the guide rail, wherein
an opening of a flow path provided inside the case is adjusted by sliding the slide damper.

2. A slide damper device according to claim 1, further comprising a shield wall shielding a fluid, the shield wall being provided at a side of a moving range of the connection member along the moving range.

3. A slide damper device according to claim 1, wherein the connection member is provided at a side end part of the slide damper along an entire area in a direction in which the slide damper slides.

4. A slide damper device according to claim 1, wherein a plurality of connection members are provided at the side end part of the slide damper in a direction in which the slide damper slides, the plurality of connection members being positioned while being distanced from one another.

5. A slide damper device according to claim 1, wherein a thickness of the connection member is smaller than a thickness of the guide rail.

6. A slide damper device adjusting an opening of a flow path provided inside a case of an air conditioning device for a vehicle by sliding a slide damper, the slide damper device comprising:
a guide provided on an inner wall of the case;
a connection member provided at a side end part of the slide damper, the connection member slidably fitting with the guide, the connection member connecting the slide damper to the guide; and
a protrusion member provided on either one of a sliding surface of the connection member with respect to the guide and a sliding surface of the guide with respect to the connection member, the connection member and the guide sliding against each other.

7. A slide damper device according to claim 6, wherein the protrusion member is provided on the sliding surface of the guide.

8. A slide damper device according to claim 7, wherein a plurality of the protrusion members are aligned while being separated from each other at a distance such that the sliding surface of the connection member is constantly contacting a plurality of the protrusion members.

9. A slide damper device according to claim 6, wherein a set of opposing surfaces comprised by the guide or the connection member are each regarded as the sliding surface, the protrusion member is provided on each of the sliding surface, and the protrusion member provided on each of the sliding surface are positioned to be out of alignment in a direction in which the slide damper slides.

10. A slide damper device according to claim 6, wherein a surface of the protrusion member is shaped as an arc warped towards a direction in which the slide damper slides.

11. A slide damper device according to claim 6, wherein
the guide is a plate-like guide rail; and
the connection member has a concave shape fitting with the guide rail.

12. A slide damper device adjusting an opening of a flow path provided inside a case of an air conditioning device for a vehicle by sliding a slide damper, the slide damper comprising:
a guide provided on an inner wall of the case;
a connection member provided at a side end part of the slide damper, the connection member slidably fitting with the guide, the connection member connecting the slide damper to the guide; and
a plurality of sliding members comprising a first sliding surface of the connection member with respect to the guide and a second sliding surface of the guide with respect to the connection member, the connection member and the guide sliding against each other, wherein
the first sliding surface of each of the sliding members or the second sliding surface of each of the sliding members are slanted.

13. A slide damper device according to claim 12, wherein
the guide is a plate-like guide rail; and
the connection member has a concave shape fitting with the guide rail.

14. A slide damper device according to claim 13, wherein the first sliding surface of the connection member with respect to the guide is slanted.

15. A slide damper device according to claim 13, wherein a first separating distance between a first tip of the guide rail at a side of the slide damper and the connection member positioned forward from the first tip is smaller than a second separating distance between a second tip of the connection member at a side of the case and the case positioned forward from the second tip.
